(19) United States
(12) Patent Application Publication
(10) Pub. No.: US 2025/0310697 A1
(43) Pub. Date: Oct. 2, 2025

(54) Vibration Generating Device

(71) Applicant: FOSTER ELECTRIC COMPANY, LIMITED, Tokyo (JP)

(72) Inventor: Daizo Okazaki, Tokyo (JP)

(21) Appl. No.: 18/864,122

(22) PCT Filed: May 1, 2023
(86) PCT No.: PCT/JP2023/017085

§ 371 Date: Nov. 8, 2024

(30) Foreign Application Priority Data
May 10, 2022 (JP) 2022-077689

(51) Int. Cl. H04R 9/02; H04R 9/06

(52) U.S. Cl. CPC H04R 9/025; H04R 9/06

(57) ABSTRACT

A vibration generating device includes: a first magnetic circuit including a pole piece, a first magnet, and a yoke that forms a magnetic gap between the pole piece; a second magnetic circuit including the pole piece, a second magnet and that repels the first magnet, and the yoke; a voice coil that is disposed in the magnetic gap and that vibrates while being affected by a magnetic field generated by the first magnetic circuit; and a reverse magnetic field separating portion that is provided at an outer peripheral edge of the pole piece, and that moves a reverse magnetic field, which is formed by the second magnetic circuit and which is opposite in direction to the magnetic field, away from the magnetic field.

### TECHNICAL FIELD

The present disclosure relates to a vibration generating device.

### BACKGROUND ART

Japanese Patent Application Laid-Open (JP-A) No. 2011-259190 and Japanese Patent Application Laid-Open (JP-A) No. 2013-201769 disclose vibration generating devices including a yoke, a permanent magnet, a pole piece, and a voice coil. The yoke includes a support portion that extends along a predetermined axis line, and a cylindrical portion that is an annular body positioned at an outer circumferential side of the support portion and centered on the axis line. The permanent magnet is fixed to an end face of the support portion in an axial direction, and the pole piece is fixed to an end face of the permanent magnet at an opposite side to the supporting portion.

A magnetic field is formed between the pole piece and the cylindrical portion. Further, a voice coil, which is an annular body, is disposed in an annular space between the pole piece and the cylindrical portion so as to interfere with the magnetic field. When current flows through the voice coil, the voice coil reciprocatingly moves along the axis line.

### SUMMARY OF INVENTION

### Technical Problem

In the vibration generating devices of JP-A No. 2011-259190 and JP-A No. 2013-201769, a magnetic field in a predetermined direction and a reverse magnetic field in a direction opposite to the magnetic field are generated, and these two magnetic fields sometimes act on the voice coil. The vibration generating devices of JP-A No. 2011-259190 and JP-A No. 2013-201769 have room for improvement with respect to suppressing the effect of the reverse magnetic field acting on the voice coil.

An object of the present disclosure is to provide a vibration generating device capable of suppressing the effect of a reverse magnetic field acting on a voice coil.

### Solution to Problem

A vibration generating device according to claim 1 includes: a first magnetic circuit including a pole piece, a first magnet that is provided at one end side, in a thickness direction, of the pole piece, and a yoke that is disposed so as to be separated from the pole piece and that forms a magnetic gap between the pole piece; a second magnetic circuit including the pole piece, a second magnet that is provided at another end side, in the thickness direction, of the pole piece and that repels the first magnet and the yoke; a voice coil that is disposed in the magnetic gap and that vibrates while being affected by a magnetic field generated by the first magnetic circuit; and a reverse magnetic field separating portion that is provided at an outer peripheral edge of the other end side of the pole piece, and that moves a reverse magnetic field, which is formed by the second magnetic circuit and which is opposite in direction to the magnetic field, away from the magnetic field.

A vibration generating device according to claim 2 includes: a first magnetic circuit including a pole piece, a yoke that is provided at a thickness direction one end side of the pole piece, a top pole that is disposed so as to be separated from the pole piece and that forms a magnetic gap between the pole piece, and a first magnet that is provided at one end side, in a thickness direction, of the top pole, a second magnetic circuit including the pole piece, a second magnet that is provided at another end side, in the thickness direction other end side, of the pole piece, and the top pole; a voice coil that is disposed in the magnetic gap and that vibrates while being affected by a magnetic field generated by the first magnetic circuit; and a reverse magnetic field separating portion that is provided at an outer peripheral edge of the other end side of the pole piece, and that moves a reverse magnetic field, which is formed by the second magnetic circuit and which is opposite in direction to the magnetic field, away from the magnetic field.

In the invention according to claims 1 and 2, the voice coil vibrates when current flows through the voice coil. If the voice coil is significantly affected by the reverse magnetic field by the second magnetic circuit, a large difference arises between the strength of the magnetic field reaching the voice coil at a region at one side in a movement direction and the strength of the magnetic field reaching the voice coil at a region at another side in the movement direction. In such a case, a large difference is generated between a force generated by the voice coil at the region at the one side and a force generated by the voice coil at the region at the other side. However, in the invention according to claims 1 and 2, a reverse magnetic field separating portion is formed at an outer peripheral edge of the thickness direction other end side of the pole piece, and moves a reverse magnetic field, which is formed by the second magnetic circuit and which is opposite in direction to the magnetic field formed by first magnetic circuit, away from the magnetic field. This suppresses the effect of a reverse magnetic field acting on the voice coil. Therefore, a large difference does not easily occur between the strength of the magnetic field reaching the voice coil at the region at the one side in the movement direction, and the strength of the magnetic field reaching the voice coil at the region at the other side in the movement direction. As a result, a large difference does not easily occur between a force generated by the voice coil at the region at one side and a force generated by the voice coil at the region at the other side.

A vibration generating device according to claim 3, is the vibration generating device according to claim 1 or claim 2, wherein the reverse magnetic field separating portion is an annular recess portion that is centered on an axis line of the pole piece and that is formed at an end portion at another end side of an outer peripheral face of the pole piece.

In the invention according to claim 3, by configuring the reverse magnetic field separating portion as an annular recess portion that is centered on the axis line of the pole piece, a space is formed between the outer peripheral edge of the thickness direction other end side of the pole piece and the voice coil. Therefore, a reverse magnetic field generated by the second magnetic circuit is formed vertically long in a vibration direction of the voice coil, and moves away from the magnetic field. This makes it difficult to form a reverse magnetic field in the vibration range of the voice coil, thereby enabling the effect of the reverse magnetic field on the voice coil to be suppressed.

A vibration generating device according to claim 4 is the vibration generating device according to claim 1, wherein: the yoke includes a cylindrical portion that is positioned at an outer circumferential side of the annular recess portion; an inner face of the annular recess portion includes an orthogonal face that is orthogonal to the axis line; and axial direction positions of an axial direction end face of the cylindrical portion and the orthogonal face are the same.

In the invention according to claim 4, by making axial direction positions of the axial direction end face of the cylindrical portion and the orthogonal face the same, the direction of the magnetic field in the magnetic gap is orthogonal to the vibration direction of the voice coil. This enables a reverse magnetic field to be formed at a desired position away from the magnetic gap, enabling the effect of the reverse magnetic field on the voice coil to be suppressed.

A vibration generating device according to claim 5 is the vibration generating device according to claim 1 or claim 4, wherein a diameter, centered on an axis line of the pole piece, of an end portion of another end side of the pole piece is substantially the same as a diameter, centered on the axis line, of the second magnet.

In the invention according to claim 5, by making an outer diameter of the second magnet substantially the same as an outer diameter of the annular recess portion, the direction of the magnetic field formed by the second magnetic circuit between the second magnet and the pole piece becomes the direction of the vibration direction of the voice coil. This enables a reverse magnetic field to be formed at a desired position away from the magnetic gap.

### Advantageous Effects of Invention

The vibration generating device of the present disclosure enables the effect of a reverse magnetic field acting on a voice coil to be suppressed.

### BRIEF DESCRIPTION OF DRAWINGS

FIG. 1 is a cross-sectional view of a speaker according to a first exemplary embodiment.

FIG. 2 is an enlarged view of relevant portions in FIG. 1.

FIG. 3 is a graph illustrating a magnetic flux density distribution and a BL curve of the first exemplary embodiment.

FIG. 4 is a cross-sectional view, similar to FIG. 2, of a comparative example of the first exemplary embodiment.

FIG. 5 is a graph illustrating a magnetic flux density distribution and a BL curve of the comparative example of the first exemplary embodiment.

FIG. 6 is a cross-sectional view, similar to FIG. 2, of a first modified example.

FIG. 7 is a graph, similar to FIG. 3, of the first modified example.

FIG. 8 is a cross-sectional view, similar to FIG. 2, of a second modified example.

FIG. 9 is a graph, similar to FIG. 3, of the second modified example.

FIG. 10 is a cross-sectional view, similar to FIG. 2, of a third modified example.

FIG. 11 is a graph, similar to FIG. 3, of the third modified example.

FIG. 12 is a cross-sectional view, similar to FIG. 2, of a fourth modified example.

FIG. 13 is a graph, similar to FIG. 3, of the fourth modified example.

FIG. 14 is a cross-sectional view, similar to FIG. 2, of a fifth modified example.

FIG. 15 is a graph, similar to FIG. 3, of the fifth modified example.

FIG. 16 is a cross-sectional view of a speaker according to a second exemplary embodiment.

FIG. 17 is an enlarged view of relevant portions in FIG. 16.

FIG. 18 is a graph, similar to FIG. 3, of the second exemplary embodiment.

FIG. 19 is a cross-sectional view, similar to FIG. 2, of a comparative example of the second exemplary embodiment.

FIG. 20 is a graph illustrating a magnetic flux density distribution and a BL curve of a comparative example of the second exemplary embodiment.

### DESCRIPTION OF EMBODIMENTS

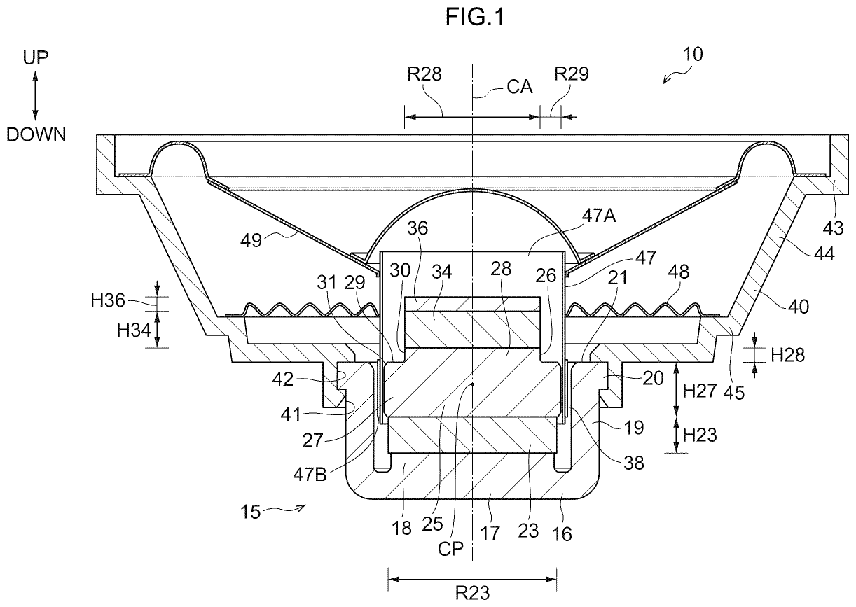

Explanation follows regarding a speaker (vibration generating device) 10 according to a first exemplary embodiment, with reference to FIG. 1 to FIG. 15. Note that for convenience of explanation, a central axis CA illustrated in FIG. 1 is assumed to be parallel to an up-down direction. When the speaker 10 is actually used, the central axis CA may be parallel to a direction that is different from the up-down direction.

As illustrated in FIG. 1, the speaker 10 includes a magnetic circuit 15, a frame 40, a voice coil 47, a damper 48, and a diaphragm 49.

The magnetic circuit 15 includes a yoke 16, a first magnet 23, a pole piece 25, a second magnet 34, and a top pole 36.

The yoke 16, which is a soft magnetic body, includes a base portion 17, a central convex portion 18, and a cylindrical portion 19. The yoke 16 is an object that is rotationally symmetric about the central axis CA. The base portion 17 is a disk. The central convex portion 18 is a columnar portion protruding upward along the central axis CA from a central portion of the base portion 17. The cylindrical portion 19 protrudes upward from an outer peripheral edge portion of the base portion 17. An annular flange 20 is formed at an upper end portion of the cylindrical portion 19. An upper end face 21 of the cylindrical portion 19 is a plane that is orthogonal to a direction that is parallel to the central axis CA. An amount by which the cylindrical portion 19 protrudes upward from the base portion 17 is greater than the central convex portion 18.

A lower face of the first magnet 23, which is a columnar hard magnetic body (permanent magnet), is fixed to an upper end face of the central convex portion 18. The first magnet 23 of the present exemplary embodiment is an Nd (neodymium) magnet. An upper side of the first magnet 23 is an N pole, and a lower side of the first magnet 23 is an S pole. An outer diameter R23 of the first magnet 23 (see FIG. 1) of the present exemplary embodiment is 18.5 mm, and an up-down direction dimension H23 of the first magnet 23 is 4.0 mm.

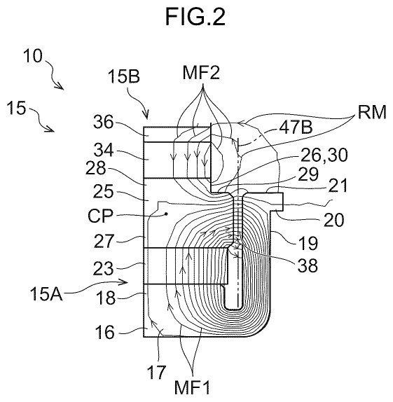

A lower face of the pole piece 25, which is a columnar soft magnetic body centered on the central axis CA, is fixed to an upper end face of the first magnet 23. The pole piece 25 is an integrally molded article. An annular recess portion (reverse magnetic field separating portion) 26 centered on the central axis CA is formed at an upper portion of an outer peripheral face of the pole piece 25. Therefore, the pole piece 25 includes a large diameter portion 27 configuring a lower portion of the pole piece 25, and a small diameter portion 28 configuring an upper portion of the pole piece 25. As illustrated in FIG. 1 and FIG. 2, an upper face of an outer peripheral portion of the large diameter portion 27 is configured by an orthogonal plane 29, which is a plane orthogonal to the central axis CA. An outer peripheral face of the small diameter portion 28 is configured by a cylindrical face 30 centered on the central axis CA. The orthogonal plane 29 and the cylindrical plane 30 are substantially orthogonal to each other. The small diameter portion 28 of the pole piece 25 configures a protruding portion that protrudes upward from the large diameter portion 27. Further, a tapered face 31, which is inclined with respect to the orthogonal plane 29 and which forms an annular shape, is formed at an outer peripheral edge portion of the orthogonal plane 29. Furthermore, the positions, in the central axis CA direction, of the upper end face 21 of the yoke 16 and the orthogonal plane 29 are the same. An up-down dimension H27 of the large diameter portion 27 (see FIG. 1) of the present exemplary embodiment is 6.0 mm, and an up-down dimension H28 of the small diameter portion 28 (see FIG. 1) is 1.6 mm. Moreover, a radial direction dimension R29 of the orthogonal plane 29 is 5.0 mm, and a diameter R28 of the small diameter portion 28 is 15.0 mm.

A lower face of the second magnet 34, which is a columnar hard magnetic body, is fixed to an upper end face of the small diameter portion 28. The second magnet 34 of the present exemplary embodiment is an Nd magnet. An outer diameter of the second magnet 34 is substantially the same as that of the small diameter portion 28. A lower side of the second magnet 34 is an N pole, and an upper side of the second magnet 34 is an S pole. Namely, the second magnet 34 and the first magnet 23 repel each other. Further, an up-down dimension H34 of the second magnet 34 (see FIG. 1) of the present exemplary embodiment is 4.0 mm.

A lower face of the top pole 36, which is a columnar soft magnetic body, is fixed to an upper end face of the second magnet 34. Further, an up-down dimension H36 of the top pole 36 (see FIG. 1) of the present exemplary embodiment is 1.6 mm. An outer diameter of the top pole 36 is substantially the same as that of the second magnet 34. Therefore, the first magnet 23 and the second magnet 34 are provided so as to be coaxial with the central convex portion 18. Namely, the magnetic circuit 15 is an internal magnetic type magnetic circuit.

A magnetic gap 38, which is an annular space centered on the central axis CA, is formed between the cylindrical portion 19 of the yoke 16 and the large diameter portion 27 of the pole piece 25.

The frame 40 is an object that is rotationally symmetric about the central axis CA. An attachment hole 41 is provided at a lower end portion of the frame 40, and an annular attachment groove 42 is formed at an inner peripheral face of the attachment hole 41. An upper end portion 43 of the frame 40 has a larger diameter than the lower end portion, and an entire upper end of the frame 40 is open. A tapered portion 44 and a step portion 45 that is connected to a lower end portion of the tapered portion 44 are provided at a portion between the lower end portion and the upper end portion 43 of the frame 40. As illustrated in FIG. 1, the flange 20 is fitted into the attachment groove 42. Namely, the lower end portion of the frame 40 is supported by the flange 20.

The voice coil 47 is provided in the magnetic gap 38. The voice coil 47 includes a bobbin 47A having a substantially cylindrical shape centered on the central axis CA, and a coil 47B that is wrapped around an outer peripheral face of the bobbin 47A and has a substantially cylindrical shape centered on the central axis CA. The voice coil 47 is capable of reciprocatingly moving linearly along the central axis CA. Both end portions of an electric wire configuring the coil 47B are connected to an AC power supply (not illustrated in the drawings) via a control device (not illustrated in the drawings). An inner peripheral portion of the damper 48 is connected to the bobbin 47A, and an outer peripheral portion of the damper 48 is connected to the step portion 45 of the frame 40.

An inner peripheral portion of the diaphragm 49, which is an annular member centered on the central axis CA, is connected to the bobbin 47A, and an outer peripheral portion of the diaphragm 49 is connected to an inner peripheral face of the upper end portion 43 of the frame 40.

Explanation follows regarding operation and advantageous effects of the first exemplary embodiment.

As illustrated in FIG. 2, in the speaker 10 according to the first exemplary embodiment, a first magnetic circuit 15A is configured by the cylindrical portion 19, the base portion 17, the central convex portion 18, the first magnet 23, and the large diameter portion 27 of the pole piece 25, and a first magnetic field (magnetic field) MF1 is formed along the first magnetic circuit 15A. The direction of the first magnetic field MF1 is the direction of the arrows illustrated in FIG. 2. Further, a second magnetic circuit 15B is configured by the large diameter portion 27 of the pole piece 25, the small diameter portion 28 of the pole piece 25, the second magnet 34, the top pole 36, and the upper end portion of the cylindrical portion 19, and a second magnetic field (reverse magnetic field) MF2 is formed along the second magnetic circuit 15B. The direction of the second magnetic field MF2 is the direction of the arrows illustrated in FIG. 2. Namely, the direction of the second magnetic field MF2 is opposite to the direction of the first magnetic field MF1. For example, the second magnetic field MF2 is illustrated in the drawings as being counterclockwise, and the first magnetic field MF1 is illustrated in the drawings as being clockwise. Therefore, in the magnetic gap 38 between the pole piece 25 and the cylindrical portion 19, the directions of the first magnetic field MF1 and the second magnetic field MF2 are the same. This enables the magnetic field density in the magnetic gap 38 to be increased, thereby enabling the vibration force of the voice coil 47 to be improved.

As is apparent from FIG. 2, the coil 47B interferes with the first magnetic field MF1 and the second magnetic field MF2. Note that reference numeral 47B illustrated in FIG. 2 is a right side edge portion of the coil 47B, and schematically indicates a movable range thereof. When electric power of the above-described AC power supply is supplied to the coil 47B, the voice coil 47 reciprocatingly moves along the central axis CA with respect to the magnetic circuit 15. Accompanying this, the diaphragm 49 vibrates in the up-down direction, thereby generating sound.

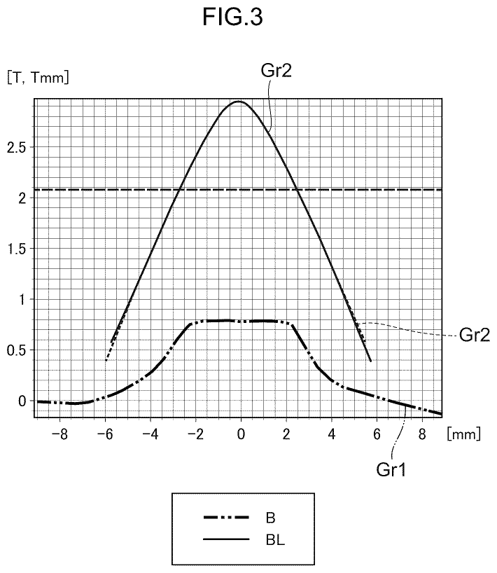

FIG. 3 illustrates a magnetic flux density distribution and a BL curve of the speaker 10. In FIG. 3, the horizontal axis indicates the position in the central axis CA direction. “0” on the horizontal axis indicates a position CP (see FIG. 1 and FIG. 2) which is the point in the central axis CA direction and is substantially coincident with the center of the large diameter portion 27 in the central axis CA in the central axis CA direction. The vertical axis indicates the magnitude of the magnetic flux density B and the BL curve. The unit of the magnetic flux density B is T (tesla), and T=N×A⁻¹×M⁻¹. The unit of the BL curve is T×M=N/A. Note that B in BL is a magnetic flux density, L is the number of turns of the coil 47B, and BL is a force coefficient. Further, A is an ampere of current, N is Newton, and M is a length of the coil 47B in the axial direction. In FIG. 3, the central point of the coil 47B in the central axis CA direction and the position in the up-down direction of the position CP are substantially the same.

The graph Gr1 in FIG. 3 indicates the magnitude of the magnetic flux density B. The graph Gr2 represented by the solid line in FIG. 3 indicates a force coefficient when a unidirectional current is supplied to the voice coil 47 from the above-described AC power supply, and the graph Gr2 represented by the dotted line indicates the graph Gr2 represented by the solid line which is mirror-inverted with respect to the central axis. When the central point of the coil 47B and the position in the up-down direction of the position CP substantially coincide with each other, the magnetic flux density B of the magnetic field reaching the coil 47B becomes large, such that the voice coil 47 generates a large driving force. On the other hand, when the central point is separated from the position CP, the magnetic flux density B of the magnetic field reaching the coil 47B becomes small, such that the driving force generated by the coil 47B becomes small.

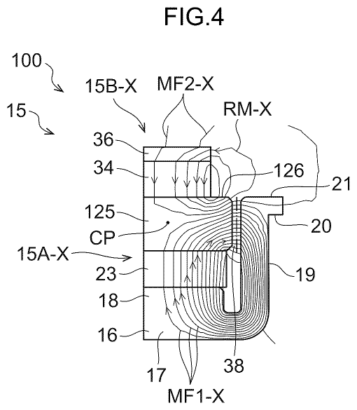

FIG. 4 illustrates a cross-sectional view, similar to FIG. 2, of a speaker 100 of a comparative example. The speaker 100 has the same configuration as the speaker 10 except for a pole piece 125. The pole piece 125 has the same configuration as the large diameter portion 27. An upper end face 126 of the pole piece 125 is a plane orthogonal to the central axis CA, and the positions, in the central axis CA direction, of the upper end face 21 of the yoke 16 and the upper end face 126 are the same.

As illustrated in FIG. 4, in the speaker 100, a first magnetic circuit 15A-X is configured by the cylindrical portion 19, the base portion 17, the central convex portion 18, the first magnet 23, and the pole piece 125, and a first magnetic field MF1-X is formed along the first magnetic circuit 15A-X. The direction of the first magnetic field MF1-X is the direction of the arrows illustrated in FIG. 4. Further, a second magnetic circuit 15B-X is configured by the pole piece 125, the second magnet 34, the top pole 36, and the upper end portion of the cylindrical portion 19, and a second magnetic field MF2-X is formed along the second magnetic circuit 15B-X. The direction of the second magnetic field MF2-X is the direction of the arrows illustrated in FIG. 4. Namely, the direction of the second magnetic field MF2-X is opposite to the direction of the first magnetic field MF1-X.

As is apparent from FIG. 2 and FIG. 4, the second magnetic field MF2 and the first magnetic field MF1 interfere (converge) with each other in the speaker 10, and the second magnetic field MF2-X and the first magnetic field MF1-X interfere (converge) with each other in the speaker 100. However, the annular recess portion 26 is formed in the pole piece 25 of the speaker 10, and the up-down dimension of the pole piece 25 is larger than that of the pole piece 125, such that the second magnetic field MF2 of the speaker 10 is positioned entirely above the second magnetic field MF2-X of the speaker 100.

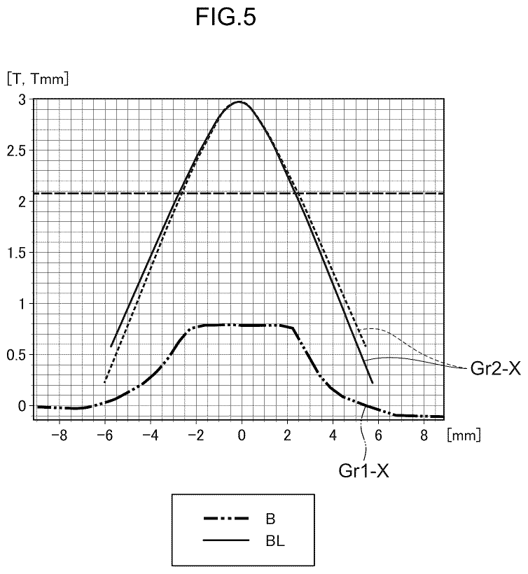

Therefore, in the graph Gr1-X in FIG. 5 illustrating the comparative example, due to the effect of the second magnetic field MF2-X, the magnitude of the magnetic flux density B becomes − (minus) in a region that is separated from the position CP which is the point in the central axis CA direction and is substantially coincident with the center of the large diameter portion 27 in the central axis CA by greater than or equal to 5.5 mm upward. Namely, in a region that is separated upward by greater than or equal to 5.5 mm from the position CP, part of the second magnetic field MF2-X becomes a reverse magnetic field RM-X (see FIG. 4) that is opposite in direction to the first magnetic field MF1-X and a main magnetic field of the second magnetic field MF2-X. This main magnetic field of the second magnetic field MF2-X is in the same direction as the first magnetic field MF1-X. In contrast thereto, in the graph Gr1 in FIG. 3 illustrating the first exemplary embodiment, although affected by the second magnetic field MF2, the magnitude of the magnetic flux density B becomes − (minus) in a region that is separated upward by greater than or equal to 6.7 mm from the position CP. Namely, in a region that is separated upward by greater than or equal to 6.7 mm from the position CP, part of the second magnetic field MF2 becomes a reverse magnetic field RM (see FIG. 2) that is opposite in direction to the first magnetic field MF1 and the main magnetic field of the second magnetic field MF2. The annular recess portion 26 is formed in the pole piece 25, and an outer diameter of the second magnet 34 is substantially the same as that of the small diameter portion 28. Therefore, a reverse magnetic field RM generated by the second magnetic circuit 15B is formed vertically long in the up-down direction and moves away from the main magnetic field. Accordingly, the reverse magnetic field RM of the present exemplary embodiment is formed above the reverse magnetic field RM-X of the comparative example. Further, in the graph Gr1 and the graph Gr1-X, the magnitude of the magnetic flux density B in the region below the position CP is + (plus) or substantially zero. Therefore, the graph Gr1 is substantially bilaterally symmetrical, whereas the graph Gr1-X is not bilaterally symmetrical.

In this manner, since the graph Gr1 is substantially bilaterally symmetrical, the graph Gr2 representing the BL curve in FIG. 3 is substantially bilaterally symmetrical. In other words, the generation region of the reverse magnetic field RM is limited to a region that is separated from the position CP by a corresponding distance upward. When the reverse magnetic field RM reaches the voice coil 47, which interferes with the main magnetic field, the movement force of the voice coil 47 is reduced due to the effect of the reverse magnetic field RM. However, in the present exemplary embodiment, the generation region of the reverse magnetic field RM is limited to a region that is separated from the position CP by a corresponding distance upward. Further, the positions, in the up-down direction, of the orthogonal plane 29 and the upper end face 21 are the same, such that the directions of the first magnetic field MF1 and the second magnetic field MF2 in the magnetic gap 38 are substantially horizontal directions. This enables a reverse magnetic field RM to be formed at a desired position that is separated upward from the magnetic gap 38. This makes it difficult for the movement force of the voice coil 47 in the region above the position CP to be reduced. Therefore, the magnitude of the movement force of the voice coil 47 in the region above the position CP is substantially the same as the magnitude of the movement force of the voice coil 47 in the region below the position CP. Accordingly, performance of the speaker 10 is unlikely to be degraded.

In contrast thereto, the graph Gr1-X is not bilaterally symmetrical, such that the graph Gr2-X representing the BL curve of the comparative example illustrated in FIG. 5 is not bilaterally symmetrical. Namely, there is a large difference between the movement force of the voice coil 47 in the region above the position CP, and the movement force of the voice coil 47 in the region below the position CP. Accordingly, performance of the speaker 100 is likely to be degraded.

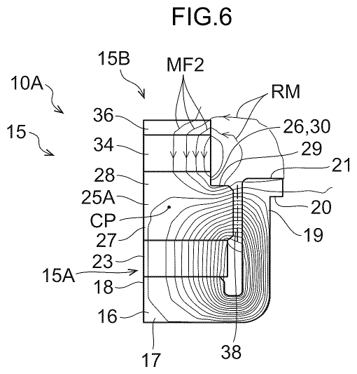

Explanation follows regarding modified examples of the first exemplary embodiment, with reference to FIG. 6 to FIG. 16.

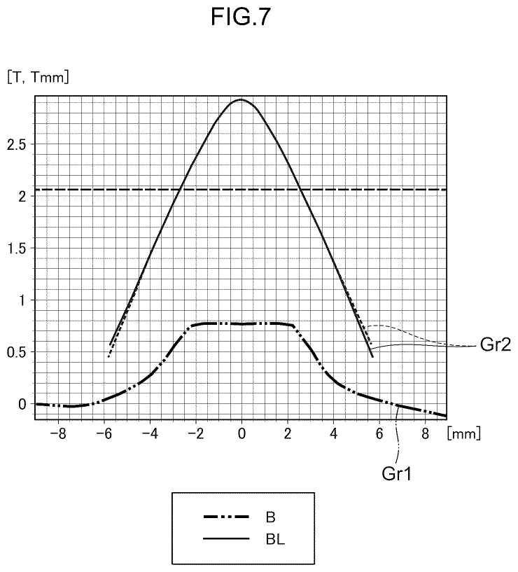

FIG. 6 and FIG. 7 illustrate a first modified example. As illustrated in FIG. 6, the orthogonal plane 29 of a pole piece 25A of a speaker (vibration generating device) 10A of the first modified example is positioned only 0.8 mm below the upper end face 21 of the yoke 16. As illustrated in FIG. 7, the graph Gr1 of the first modified example is also substantially bilaterally symmetrical. This is because the annular recess portion 26 is formed in the pole piece 25A, and an amount of positional deviation in the up-down direction between the orthogonal plane 29 and the upper end face 21 is small. In a case in which there is only a small amount of positional deviation in the up-down direction between the orthogonal plane 29 and the upper end face 21, the directions of the first magnetic field MF1 and the second magnetic field MF2 in the magnetic gap 38 are substantially horizontal directions. Therefore, as illustrated in FIG. 7, the graph Gr2 representing the BL curve is also substantially bilaterally symmetrical.

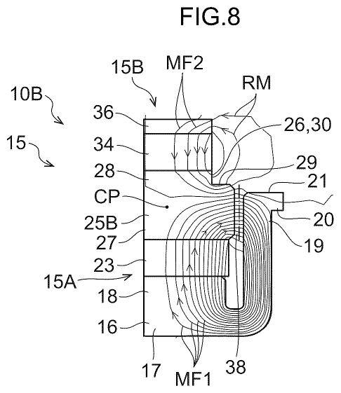

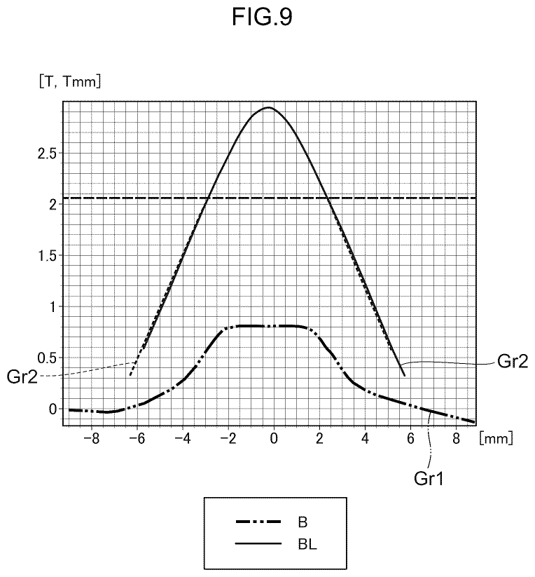

FIG. 8 and FIG. 9 illustrate a second modified example. As illustrated in FIG. 8, the orthogonal plane 29 of a pole piece 25B of a speaker (vibration generating device) 10B of the second modified example is positioned only 0.8 mm above the upper end face 21 of the yoke 16. As illustrated in FIG. 9, the graph Gr1 of the second modified example is also substantially bilaterally symmetrical. This is because the annular recess portion 26 is formed in the pole piece 25B, and an amount of positional deviation in the up-down direction between the orthogonal plane 29 and the upper end face 21 is small. Therefore, as illustrated in FIG. 9, the graph Gr2 representing the BL curve is also substantially bilaterally symmetrical.

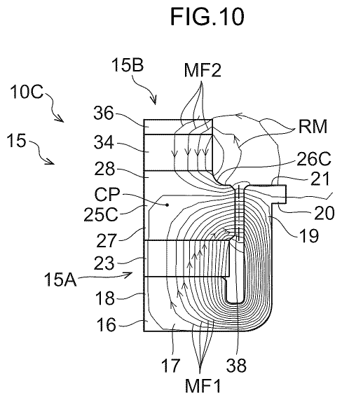

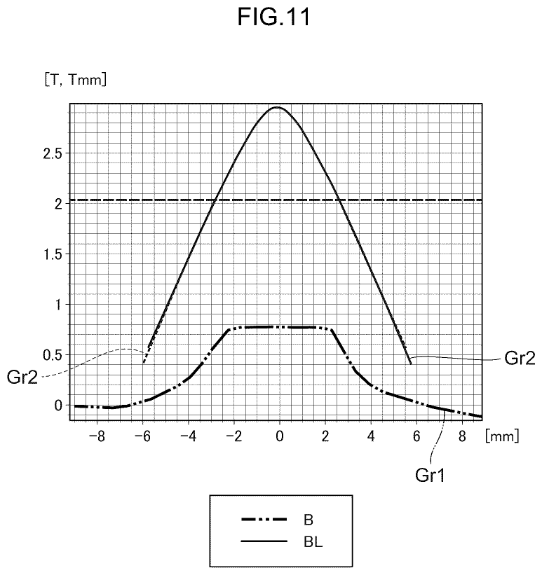

FIG. 10 and FIG. 11 illustrate a third modified example. As illustrated in FIG. 10, a cross-sectional shape of an inner face of an annular recess portion (reverse magnetic field separating portion) 26C of a pole piece 25C of a speaker (vibration generating device) 10C of a third modified example is a substantially circular-arc face. The radius of curvature R of the circular-arc face is 1.6 mm. As illustrated in FIG. 11, the graph Gr1 of the third modified example is also substantially bilaterally symmetrical. This is because the annular recess portion 26C is formed in the pole piece 25B, and the positions, in the up-down direction, of a lower end of the annular recess portion 26C and the upper end face 21 are the same. Therefore, as illustrated in FIG. 11, the graph Gr2 representing the BL curve is also substantially bilaterally symmetrical. Note that the third modified example may be applied to the above-described first modified example and second modified example.

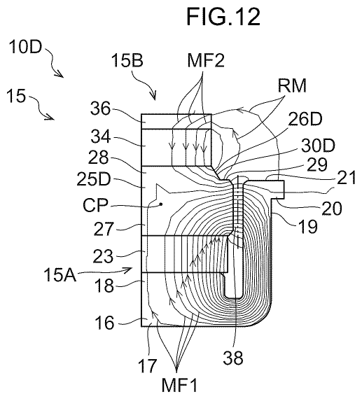

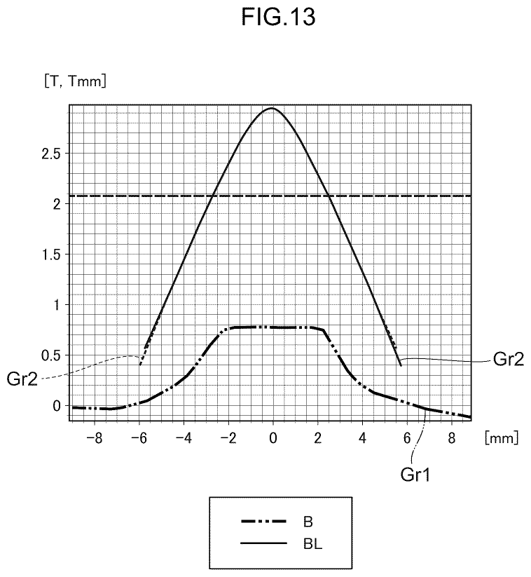

FIG. 12 and FIG. 13 illustrate a fourth modified example. As illustrated in FIG. 12, part of an inner face of an annular recess portion (reverse magnetic field separating portion) 26D of a pole piece 25D of a speaker (vibration generating device) 10D of the fourth modified example is a tapered face 30D centered on the central axis CA. Further, another part of the inner face of the annular recess portion 26D is the orthogonal plane 29. As illustrated in FIG. 13, the graph Gr1 of the fourth modified example is also substantially bilaterally symmetrical. This is because the annular recess portion 26D is formed in the pole piece 25D, and the positions, in the up-down direction, of the orthogonal plane 29 and the upper end face 21 are the same. Therefore, as illustrated in FIG. 13, the graph Gr2 representing the BL curve is also substantially bilaterally symmetrical. Note that the fourth modified example may be applied to the above-described first modified example and second modified example.

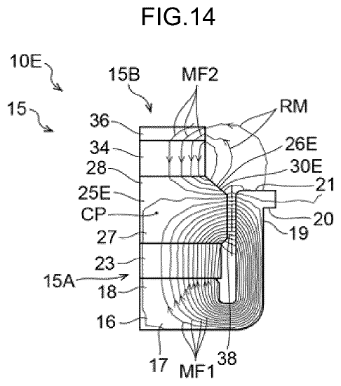

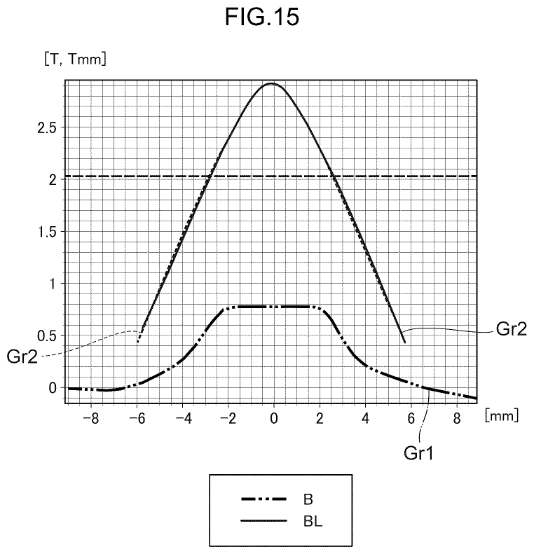

FIG. 14 and FIG. 15 illustrate a fifth modified example. As illustrated in FIG. 14, an entirety of an inner face of an annular recess portion (reverse magnetic field separating portion) 26E of a pole piece 25E of a speaker 10E of the fifth modified example is configured by a tapered face 30E centered on the central axis CA. As illustrated in FIG. 15, the graph Gr1 of the fifth modified example is also substantially bilaterally symmetrical. This is because the annular recess portion 26E is formed in the pole piece 25E, and the positions, in the up-down direction, of a lower end of the tapered face 30E and the upper end face 21 are the same. Therefore, as illustrated in FIG. 15, the graph Gr2 representing the BL curve is also substantially bilaterally symmetrical. Note that the fifth modified example may be applied to the above-described first modified example and second modified example.

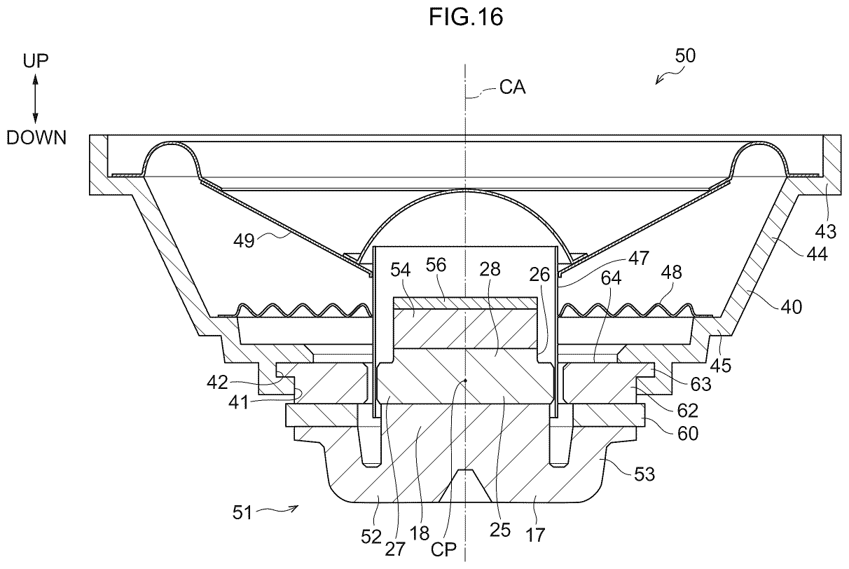

Explanation follows regarding a speaker (vibration generating device) 50 according to a second exemplary embodiment, with reference to FIG. 16 to FIG. 20. The configuration of the speaker 50 is different from that of the speaker 10 in terms of the configuration of a magnetic circuit 51. Note that in the following explanation, the same reference numerals as in the first exemplary embodiment are appended to members that are the same as in the first exemplary embodiment, and members that have slightly different structures but can be regarded as being substantially the same.

The magnetic circuit 51 of the second exemplary embodiment includes the pole piece 25, a yoke 52, a second magnet 54, a first top pole 56, a second magnet 60, and a second top pole 62.

The yoke 52, which is a soft magnetic body, includes the base portion 17, the central convex portion 18, and a cylindrical portion 53. An up-down dimension of the cylindrical portion 53 is shorter than that of the cylindrical portion 19.

The lower face of the pole piece 25 is fixed to the upper end face of the central convex portion 18.

A lower face of the second magnet 54, which is a columnar hard magnetic body (permanent magnet), is fixed to an upper end face of the pole piece 25. The second magnet 54 of the present exemplary embodiment is an Nd magnet. An outer diameter of the second magnet 54 is substantially the same as that of the small diameter portion 28. An upper side of the second magnet 54 is an S pole, and a lower side of the second magnet 54 is an N pole.

A lower face of the first top pole 56, which is a columnar soft magnetic body, is fixed to an upper end face of the second magnet 54. An outer diameter of the first top pole 56 is substantially the same as that of the second magnet 54. Therefore, the pole piece 25, the second magnet 54, and the first top pole 56 are provided so as to be coaxial with the central convex portion 18.

A lower face of the first magnet 60, which is an annular hard magnetic body (permanent magnet), is fixed to an upper face of the cylindrical portion 53. The first magnet 60 of the present exemplary embodiment is an Nd magnet. An upper side of the first magnet 60 is an S pole, and a lower side of the first magnet 60 is an N pole.

A lower face of the second top pole 62, which is an annular soft magnetic body, is fixed to an upper end face of the first magnet 60. An annular flange 63 is formed at an upper end portion of the second top pole 62. An upper end face 64 of the second top pole 62 is a plane that is orthogonal to the direction that is parallel to the central axis CA. Therefore, the first magnet 60 and the second top pole 62 are provided at an outer circumferential side of the central convex portion 18. Namely, the magnetic circuit 51 is an external magnetic type magnetic circuit.

As illustrated in FIG. 16, the flange 63 is fitted into the attachment groove 42. Namely, the lower end portion of the frame 40 is supported by the flange 63.

Explanation follows regarding operation and advantageous effects of the second exemplary embodiment.

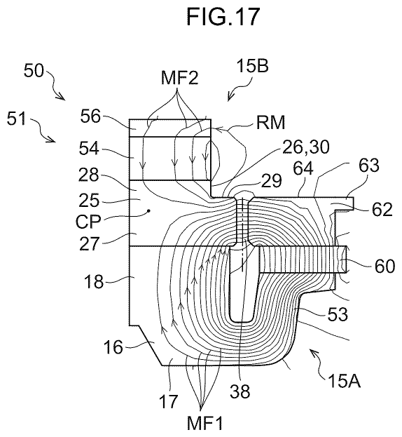

As illustrated in FIG. 17, in the speaker 50 according to the second exemplary embodiment, the first magnetic circuit 15A is configured by the cylindrical portion 53, the base portion 17, the central convex portion 18, the large diameter portion 27 of the pole piece 25, the first magnet 60, and the second top pole 62, and the first magnetic field MF1 is formed along the first magnetic circuit 15A. The direction of the first magnetic field MF1 is the direction of the arrows illustrated in FIG. 17. Further, the second magnetic circuit 15B is configured by the large diameter portion 27 of the pole piece 25, the small diameter portion 28 of the pole piece 25, the second magnet 54, and the first top pole 56, and the second magnetic field MF2 is formed along the second magnetic circuit 15B. The direction of the second magnetic field MF2 is the direction of the arrows illustrated in FIG. 17, and is opposite to the direction of the first magnetic field MF1. For example, the second magnetic field MF2 is illustrated in the drawings as being counterclockwise, and the first magnetic field MF1 is illustrated in the drawings as being clockwise. Therefore, in the magnetic gap 38 between the pole piece 25 and the second top pole 62, the directions of the first magnetic field MF1 and the second magnetic field MF 2 are the same. This enables the magnetic field density in the magnetic gap 38 to be increased, thereby enabling the vibration force of the voice coil 47 to be improved.

When electric power of the above-described AC power supply is supplied to the coil 47B, the voice coil 47 reciprocatingly moves along the central axis CA with respect to the magnetic circuit 51, and the diaphragm 49 vibrates in the up-down direction, such that sound is generated.

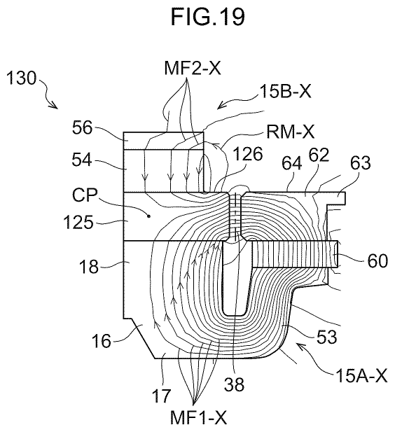

FIG. 19 illustrates a cross-sectional view, similar to FIG. 17, of a speaker 130 of a comparative example of the second exemplary embodiment. The speaker 130 has the same configuration as the speaker 50 except for the pole piece 125. The positions, in the central axis CA direction, of the upper end face 64 of the second top pole 62 and the upper end face 126 of the pole piece 125 are the same.

As illustrated in FIG. 19, in the speaker 130 of the comparative example, the first magnetic circuit 15A-X is configured by the cylindrical portion 53, the base portion 17, the central convex portion 18, the pole piece 125, the first magnet 60, and the second top pole 62, and the first magnetic field MF1-X is formed along the first magnetic circuit 15A-X. The direction of the first magnetic field MF1-X is the direction of the arrows illustrated in FIG. 19. Further, the second magnetic circuit 15B-X is configured by the pole piece 125, the second magnet 54, and the first top pole 56, and the second magnetic field MF2-X is formed along the second magnetic circuit 15B-X. The direction of the second magnetic field MF2-X is the direction of the arrows illustrated in FIG. 19, and is opposite to the direction of the first magnetic field MF1-X.

As is apparent from FIG. 17 and FIG. 19, the second magnetic field MF2 and the first magnetic field MF1 interfere (converge) with each other in the speaker 50, and the second magnetic field MF2-X and the first magnetic field MF1-X interfere (converge) with each other in the speaker 130. However, the annular recess portion 26 is formed in the pole piece 25 of the speaker 50, and the up-down dimension of the pole piece 25 is larger than that of the pole piece 125, such that the second magnetic field MF2 of the speaker 50 is positioned entirely above the second magnetic field MF2-X of the speaker 130.

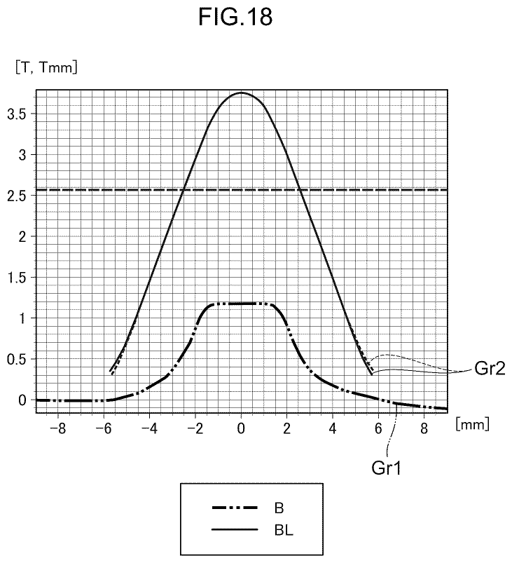

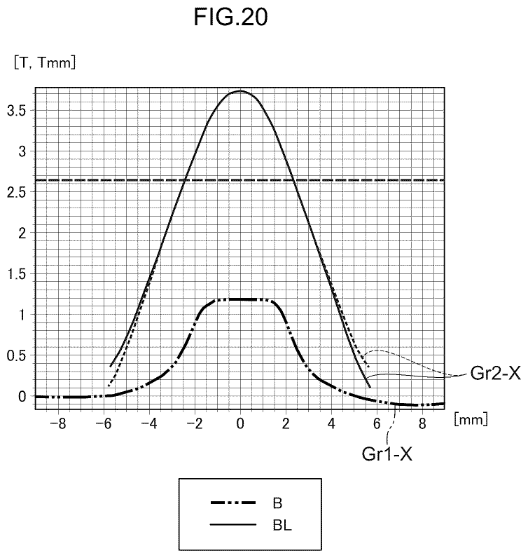

Therefore, in the graph Gr1-X in FIG. 20 illustrating the comparative example, due to the effect of the second magnetic field MF2-X, the magnitude of the magnetic flux density B becomes − (minus) in a region that is separated upward by greater than or equal to 5.5 mm from the position CP. Namely, in a region that is separated upward by greater than or equal to 5.5 mm from the position CP, part of the second magnetic field MF2-X becomes a reverse magnetic field RM-X (see FIG. 19) that is opposite in direction to the main magnetic field. In contrast thereto, in the graph Gr1 in FIG. 18 illustrating the second exemplary embodiment, although affected by the second magnetic field MF2, the magnitude of the magnetic flux density B becomes − (minus) in a region that is separated upward by greater than or equal to 6.0 mm from the position CP. Namely, in a region that is separated upward by greater than or equal to 6.0 mm from the position CP, part of the second magnetic field MF2 becomes a reverse magnetic field RM (see FIG. 17) that is opposite in direction to the main magnetic field. The annular recess portion 26 is formed in the pole piece 25, and an outer diameter of the second magnet 54 is substantially the same as that of the small diameter portion 28. Therefore, a reverse magnetic field RM generated by the second magnetic circuit 15B is formed vertically long in the up-down direction and moves away from the main magnetic field. Accordingly, the reverse magnetic field RM of the present exemplary embodiment is formed above the reverse magnetic field RM-X of the comparative example. In the graph Gr1 and the graph Gr1-X, the magnitude of the magnetic flux density B in the region below the position CP is + (plus) or substantially zero. Therefore, the graph Gr1 is almost bilaterally symmetrical, whereas the graph Gr1-X is not bilaterally symmetrical.

In this manner, since the graph Gr1 is substantially bilaterally symmetrical, the graph Gr2 in FIG. 18, representing the BL curve of the second exemplary embodiment, is substantially bilaterally symmetrical. In other words, the generation region of the reverse magnetic field RM is limited to a region that is separated from the position CP by only a corresponding distance upward. Further, the positions, in the up-down direction, of the orthogonal plane 29 and the upper end face 64 are the same, such that the directions of the first magnetic field MF1 and the second magnetic field MF2 in the magnetic gap 38 are substantially horizontal directions. This enables a reverse magnetic field RM to be formed at a desired position that is separated upward from the magnetic gap 38. This makes it difficult for the movement force of the voice coil 47 in the region above the position CP to be reduced. Therefore, the magnitude of the movement force of the voice coil 47 in the region above the position CP is substantially the same as the magnitude of the movement force of the voice coil 47 in the region below the position CP. Accordingly, performance of the speaker 50 is unlikely to be degraded.

In contrast thereto, the graph Gr1-X is not bilaterally symmetrical, such that the graph Gr2-X representing the BL curve of the comparative example illustrated in FIG. 20 is not bilaterally symmetrical. Namely, there is a large difference between the movement force of the voice coil 47 in the region above the position CP, and the movement force of the voice coil 47 in the region below the position CP. Accordingly, the performance of the speaker 130 is likely to be degraded.

Although the present disclosure has been described above based on the first exemplary embodiment and the second exemplary embodiment, the present disclosure can be appropriately modified in design without departing from the gist thereof.

For example, the respective technical ideas of the first to the fifth modified examples may be applied to the second exemplary embodiment.

Each of the above-described permanent magnets may be a ferrite magnet.

The magnetic circuits 15, 51 and the voice coil 47 may be utilized as configuration members of a vibration generating device different from a speaker. For example, the magnetic circuit 15 and the voice coil 47 may be used as configuration members of a vibration actuator.

After separately manufacturing the large diameter portion 27 and the small diameter portion 28, respectively, the large diameter portion 27 and the small diameter portion 28 may be joined together to manufacture the pole piece 25.

The reverse magnetic field separating portion may be configured with a configuration different from the annular recess portion.

The disclosure of Japanese Patent Application No. 2022-077689, filed May 10, 2022, is hereby incorporated by reference in its entirety.

All documents, patent applications, and technical standards described herein are hereby incorporated by reference to the same extent as if each document, patent application, and technical standard were specifically and individually stated to be incorporated by reference.

### EXPLANATION OF REFERENCE NUMERALS

10 10A 10B 10C 10D 100 speaker (vibration generating device)
16 yoke
18 central convex portion
19 cylindrical portion
23 first magnet
25 25A 25B 25C 25D 25E pole piece
26 26C 26D 26E annular recess portion (reverse magnetic field separating portion)
29 orthogonal plane
34 second magnet
38 magnetic gap
47 voice coil
50 speaker (vibration generating device)
52 yoke
53 cylindrical portion
60 second magnet
62 second top pole
CA central axis
RM reverse magnetic field

1. A vibration generating device, comprising:
a first magnetic circuit including a pole piece, a first magnet that is provided at one end side, in a thickness direction, of the pole piece, and a yoke that is disposed so as to be separated from the pole piece and that forms a magnetic gap between the pole piece;
a second magnetic circuit including the pole piece, a second magnet that is provided at another end side, in the thickness direction, of the pole piece and that repels the first magnet and the yoke;
a voice coil that is disposed in the magnetic gap and that vibrates while being affected by a magnetic field generated by the first magnetic circuit; and
a reverse magnetic field separating portion that is provided at an outer peripheral edge of the other end side of the pole piece, and that moves a reverse magnetic field, which is formed by the second magnetic circuit and which is opposite in direction to the magnetic field, away from the magnetic field.

2. A vibration generating device, comprising:
a first magnetic circuit including a pole piece, a yoke that is provided at a thickness direction one end side of the pole piece, a top pole that is disposed so as to be separated from the pole piece and that forms a magnetic gap between the pole piece, and a first magnet that is provided at one end side, in a thickness direction, of the top pole;
a second magnetic circuit including the pole piece, a second magnet that is provided at another end side, in the thickness direction other end side, of the pole piece, and the top pole;
a voice coil that is disposed in the magnetic gap and that vibrates while being affected by a magnetic field generated by the first magnetic circuit; and
a reverse magnetic field separating portion that is provided at an outer peripheral edge of the other end side of the pole piece, and that moves a reverse magnetic field, which is formed by the second magnetic circuit and which is opposite in direction to the magnetic field, away from the magnetic field.

3. The vibration generating device according to claim 1, wherein the reverse magnetic field separating portion is an annular recess portion that is centered on an axis line of the pole piece and that is formed at an end portion at another end side of an outer peripheral face of the pole piece.

4. The vibration generating device according to claim 3, wherein:
the yoke includes a cylindrical portion that is positioned at an outer circumferential side of the annular recess portion;
an inner face of the annular recess portion includes an orthogonal face that is orthogonal to the axis line; and
axial direction positions of an axial direction end face of the cylindrical portion and the orthogonal face are the same.

5. The vibration generating device according to claim 1, wherein a diameter, centered on an axis line of the pole piece, of an end portion of another end side of the pole piece is substantially the same as a diameter, centered on the axis line, of the second magnet.

6. The vibration generating device according to claim 2, wherein the reverse magnetic field separating portion is an annular recess portion that is centered on an axis line of the pole piece and that is formed at an end portion at another end side of an outer peripheral face of the pole piece.

7. The vibration generating device according to claim 4, wherein a diameter, centered on an axis line of the pole piece, of an end portion of another end side of the pole piece is substantially the same as a diameter, centered on the axis line, of the second magnet.
